(19) United States
(12) Patent Application Publication
(10) Pub. No.: US 2008/0216005 A1
(43) Pub. Date: Sep. 4, 2008

(54) DISPLAY PROCESSING APPARATUS, DISPLAY PROCESSING METHOD AND COMPUTER PROGRAM PRODUCT

(76) Inventors: Akiko Bamba, Tokyo (JP); Shuuichi Takeda, Tokyo (JP)

Correspondence Address: DICKSTEIN SHAPIRO LLP, 1825 EYE STREET NW, Washington, DC, 20006-5403, US

(21) Appl. No.: 12/039,167

(22) Filed: Feb. 28, 2008

(30) Foreign Application Priority Data
Mar. 2, 2007 (JP) 2007-052886

(51) Int. Cl. G06F 3/048

(52) U.S. Cl. 715/765

(57) ABSTRACT

A display processing unit displays on a display unit a first selection screen on which a plurality of upper item symbols corresponding to respective upper setting items are arranged. A selection receiving unit receives a selection of an upper item symbol. When the selection of the upper item symbol is received, the display processing unit shifts a selected upper item symbol to a specified width position with a predetermined width in a predetermined distance from one side of a screen, and displays on the display unit a second selection screen on which other displayed upper item symbols are rearranged with an arrangement order unchanged.

### CROSS-REFERENCE TO RELATED APPLICATIONS

The present application claims priority to and incorporates by reference the entire contents of Japanese priority document 2007-052886 filed in Japan on Mar. 2, 2007.

### BACKGROUND OF THE INVENTION

1. Field of the Invention

The present invention relates to a technology of display processing of a selection screen for setting and executing a function.

2. Description of the Related Art

Recently, an image forming apparatus called a multi function product (MFP) is known, which accommodates functions of various devices, such as a printer, a photocopier, a facsimile, and a scanner, into one housing. The MFP includes a display unit, a printing unit, an imaging unit, and the like, in one housing, with respective software programs for corresponding devices, and is configured to operate as each of the devices by switching the software programs.

The conventional MFP is provided with a display operation unit, such as a liquid crystal display touch panel, for setting functional conditions when executing the above functions. Because of a large number of items to be set as well as a plurality of functions included, a recent MFP is required to display an easily understandable setting screen (selection screen), and to reduce an operational load on a user for setting.

In relation to this, for example, instead of displaying all setting items of multiple functions on one screen at once, a method has been achieved that setting screens of respective functions are switched and displayed by selecting a certain button or a tab. For example, Japanese Patent Application Laid-Open Publication No. 2000-227849 discloses a technology, in which setting items like indexes of a loose-leaf file are-provided on each setting screen of a function, and when a setting item is selected, a setting screen of the selected setting item is displayed in the front, and items of conditions become ready to be set. If another setting item is then selected, a setting screen of the function is displayed in the front, and similarly, items of conditions become ready to be set.

However, according to the displaying method described in the patent document, the setting items of the setting screen of each function are displayed by arranging in the same size along a horizontal line, consequently, the setting items look similar one another and are difficult to read, and furthermore, it is difficult to grasp at sight which item is currently selected. Moreover, if setting items are not managed to be displayed on a horizontal row on the setting screen, a plurality of rows of setting items are to be displayed by arranging the rows vertically. In such case, if setting items in an upper row are displayed after displaying setting items in a lower row, a setting screen of the setting item in the upper row is displayed in the front, and the setting items in the lower row are replaced with the setting items in the upper row, so that it becomes difficult to grasp which setting item has been set, and at which position a setting item desired to be set is present.

### SUMMARY OF THE INVENTION

It is an object of the present invention to at least partially solve the problems in the conventional technology.

According to an aspect of the present invention, there is provided a display processing apparatus including a display processing unit that displays on a display unit a first selection screen on which a plurality of upper item symbols corresponding to respective upper setting items are arranged; and a selection receiving unit that receives a selection of an upper item symbol. When the selection of the upper item symbol is received, the display processing unit shifts a selected upper item symbol to a specified width position with a predetermined width in a predetermined distance from one side of a screen, and displays on the display unit a second selection screen on which other displayed upper item symbols are rearranged with an arrangement order unchanged.

Furthermore, according to another aspect of the present invention, there is provided a display processing method including displaying a first selection screen on which a plurality of upper item symbols corresponding to respective upper setting items are arranged; and receiving a selection of an upper item symbol. When the selection of the upper item symbol is received, the displaying includes shifting a selected upper item symbol to a specified width position with a predetermined width in a predetermined distance from one side of a screen, and displaying a second selection screen on which other displayed upper item symbols are rearranged with an arrangement order unchanged.

Moreover, according to still another aspect of the present invention, there is provided a computer program product comprising a computer-usable medium having computer-readable program codes embodied in the medium that when executed cause a computer to execute displaying a first selection screen on which a plurality of upper item symbols corresponding to respective upper setting items are arranged; and receiving a selection of an upper item symbol. When the selection of the upper item symbol is received, the displaying includes shifting a selected upper item symbol to a specified width position with a predetermined width in a predetermined distance from one side of a screen, and displaying a second selection screen on which other displayed upper item symbols are rearranged with an arrangement order unchanged.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a functional block diagram of an MFP that can perform functions of a display processing apparatus according to a first embodiment of the present invention;

FIG. 2 is a schematic diagram of an example of an operation panel of the MFP shown in FIG. 1;

FIG. 3 is a schematic diagram of an example of a Home screen as a selection screen according to the first embodiment;

FIG. 4 is a schematic diagram of another example of a selection screen displayed by the MFP;

FIG. 5 is a schematic diagram for explaining relation between a selected menu icon and the other menu icons displayed by the MFP;

FIG. 6 is a schematic diagram for explaining relation between a selected menu icon and the other menu icons displayed by the MFP;

FIG. 7 is a schematic diagram of still another example of a selection screen displayed by the MFP;

FIG. 8 is a schematic diagram of still another example of a selection screen displayed by the MFP;

FIG. 9 is a flowchart of a total flow of display processing according to the first embodiment;

FIG. 10 is a schematic diagram of an example of a Home screen as a selection screen according to a second embodiment of the present invention;

FIG. 11 is a flowchart of a total flow of display processing according to the second embodiment;

FIG. 12 is a schematic diagram of an example of a Home screen as a selection screen according to a third embodiment of the present invention;

FIG. 13 is a schematic diagram of an example of a Home screen as a selection screen according to a fourth embodiment of the present invention;

FIG. 14 is a schematic diagram of an example of a Home screen as a selection screen according to a fifth embodiment of the present invention; and

FIG. 15 is a block diagram of a hardware configuration of the MFP according to the first to fifth embodiments.

### DETAILED DESCRIPTION OF THE PREFERRED EMBODIMENTS

Exemplary embodiments of the present invention will be explained in detail below with reference to the accompanying drawings. The following embodiments are explained below in a case where a display processing apparatus according to each embodiment of the present invention is applied to a multi function product (MFP), which accommodates a plurality of functions, such as a photocopier, a facsimile, and a printer, into a single housing.

A display processing apparatus according to a first embodiment of the present invention is configured to display a selection screen on which a plurality of menu icons are arranged, and when one of the menu icons is selected, the display processing apparatus is to display a changed selection screen on which the menu icons are rearranged such that the selected menu icon is arranged at a specified width position, which is a predetermined width in a certain distance from a certain side of the screen and indicates that a symbol at the specified with position is selected. The changed selection screen means a selection screen that is to be displayed when one of the menu icons is selected.

An icon is a picture or a pictograph presented on the displayed screen for representing a piece of data or a function of processing. The menu icons correspond to respective menu items that are items of functions of the apparatus, and are provided for performing a selecting instruction from menu items. According to the first embodiment, the screen displays thereon icons, however, embodiments of the present invention are not limited this, but also the screen can display symbols that include icons, and marks and character strings representing various data and processing functions.

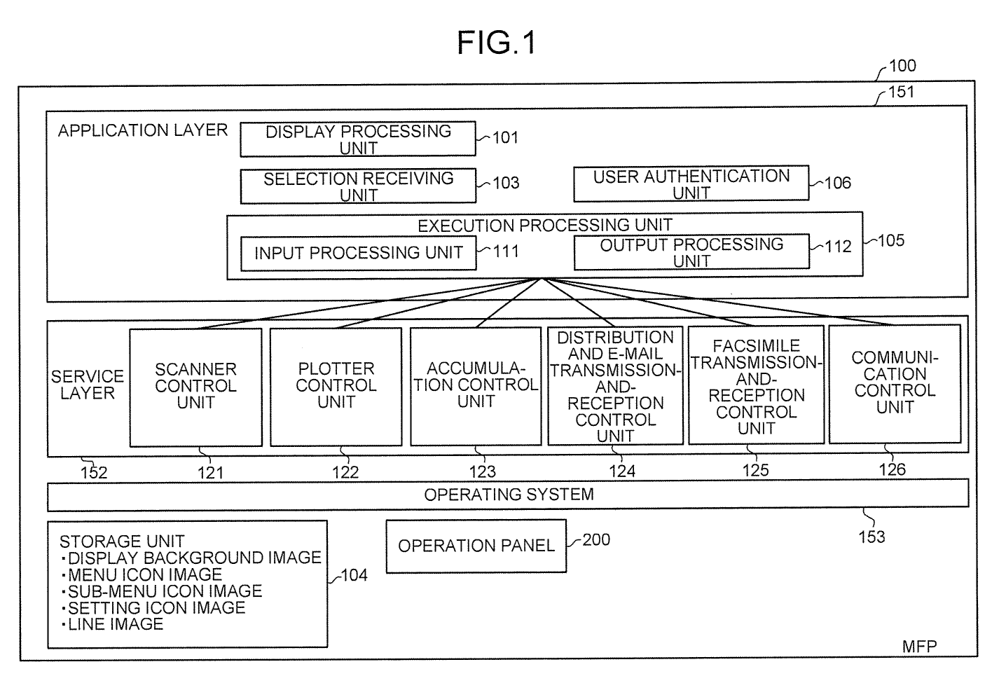

As shown in FIG. 1, an MFP 100 that can perform functions of the display processing apparatus according to the first embodiment includes an operating system 153, a service layer 152, an application layer 151, a storage unit 104, and an operation panel 200.

Functions of the MFP 100 have a hierarchical relationship as shown in FIG. 1. The service layer 152 is constructed in a layer above the operating system 153, and the application layer 151 is constructed in a layer above the service layer 152. The application layer 151 includes features of the first embodiment.

The operating system 153 manages resources of the MFP 100 including hardware resources, and provides functions that use the resources to the service layer 152 and the application layer 151.

The service layer 152 corresponds to a driver that controls hardware resources included in the MFP 100. Various functions are to be performed in response to a request of output processing from an execution processing unit 105 in the application layer 151, by controlling hardware resources included in the MFP 100 with a scanner control unit 121, a plotter control unit 122, an accumulation control unit 123, a distribution and e-mail transmission-and-reception control unit 124, a facsimile transmission-and-reception control unit 125, a communication control unit 126, and the like.

The storage unit 104 stores therein image data read from a paper material, or received as an e-mail or a facsimile. Moreover, the storage unit 104 stores therein respective icon images of menu icons, sub-menu icons, and setting icons as images to be displayed on the operation panel 200.

The sub-menu icon is a lower item icon to be used for giving an instruction to select a sub-menu item that is a lower item of a menu item. Each sub-menu icon is stored in the storage unit 104 in an associated manner with a menu item to which the sub-menu item belongs. Associations can be established by storing in the storage unit 104 a table in which the file name of a sub-menu icon is associated with the file name of a menu icon.

The setting icon is a lower item icon to be used for giving an instruction to select a setting item available to be set, which is a lower item of a menu item or a sub-menu item. Each setting icon is stored in the storage unit 104 in an associated manner with the menu icon of a menu item to which the setting item belongs, or the sub-menu icon of a sub-menu item to which the setting item belongs. Associations can be established by storing in the storage unit 104 a table in which the file name of a setting icon is associated with the file name of a menu icon or the file name of a sub-menu icon.

Furthermore, the storage unit 104 stores therein an image of a display background (display background image), which is an available area for the menu icons, the sub-menu icons, and the setting icons to be arranged, and a line image of a curve or a straight line that connects the menu icons.

The storage unit 104 can store therein data, such as image data, and can be constructed from any recording medium that is generally used, for example, a hard disk drive (HDD), an optical disk, or a memory card.

The operation panel 200 is a user interface that displays thereon a selection screen, and receives input on the selection screen.

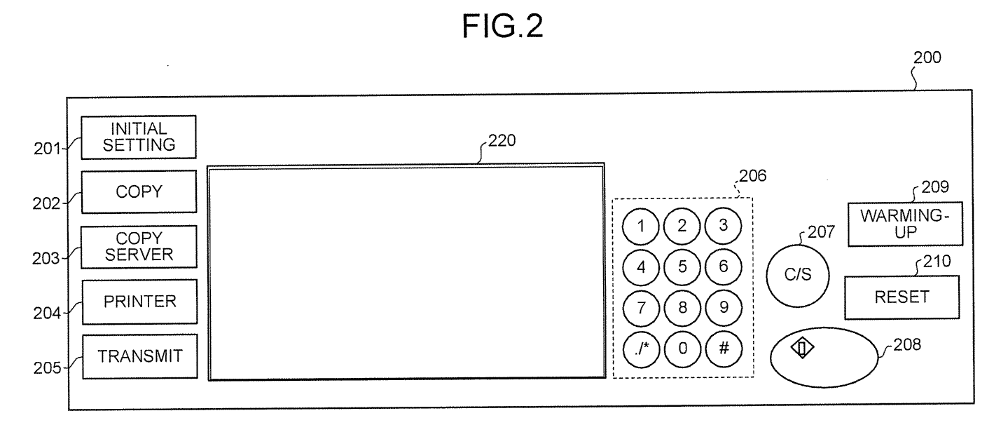

As shown in FIG. 2, the operation panel 200 includes an initial setting key 201, a copy key 202, a copy server key 203, a printer key 204, a transmission key 205, ten keys 206, a clear-stop key 207, a start key 208, a warming-up key 209, a reset key 210, and a liquid crystal display (LCD) touch panel 220. The LCD touch panel 220 is configured to display thereon a screen representing features of the first embodiment, which will be described later. The operation panel 200 includes a central processing unit (CPU) in its inside separately from a CPU of the MFP 100. The CPU inside the operation panel 200 controls display of various screens on the LCD touch panel 220, and key input from various keys or the LCD touch panel 220. The CPU inside the operation panel 200 performs only screen display control and key input control, therefore, has a lower performance than the CPU of the MFP 100.

Although the MFP 100 includes various hardware resources, such as a scanner and a plotter, in addition to the storage unit 104 and the operation panel 200, explanations of them will be described later.

Returning to FIG. 1, the application layer 151 includes a display processing unit 101, a selection receiving unit 103, the execution processing unit 105, and a user authentication unit 106.

The user authentication unit 106 performs user authentication when a user uses the MFP 100. As a method of authentication, any authentication method can be used, regardless whether the authentication is known by a person skilled in the art. When user authentication is successfully finished by the user authentication unit 106, the user is permitted to use a specific function of the MFP 100. As a permissible function, for example, transmitting and receiving of e-mail is conceivable. The user authentication by the user authentication unit 106 is to be performed at first, and it is assumed that the user authentication has been already finished in principle when performing other processing described below.

The display processing unit 101 displays on the LCD touch panel 220 a screen, for example, a selection screen for executing a function, or selecting and setting an setting item. According to the first embodiment, the display processing unit 101 performs switching of display by displaying a selection screen on which menu icons are arranged in a V-shaped formation or a straight formation, and displaying a changed selection screen of the selection screen on which a menu icon selected by the selection receiving unit 103 is shifted vertically downward on the LCD touch panel 220, and the rest of menu icons other than the selected menu icon are rearranged while maintaining the arrangement order of the menu icons. Moreover, the display processing unit 101 displays sub-menu icons of sub-menu items that belong to the menu item of the selected menu icon below an arrangement area of the menu icons.

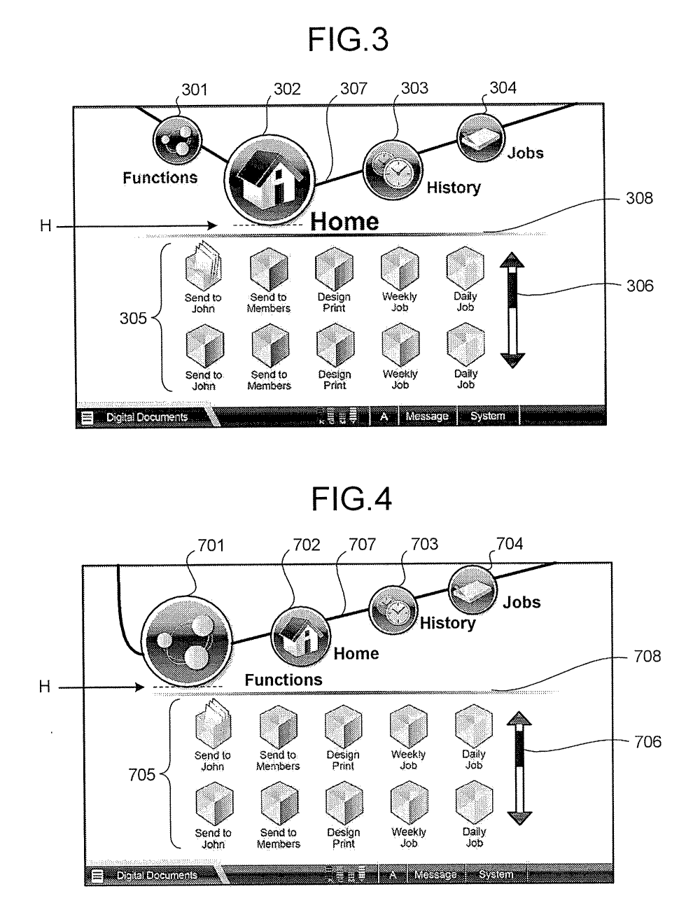

A Home screen shown in FIG. 3 is a selection screen on which the display processing unit 101 displays menu icons dedicated to a user, when user authentication for the user is successfully finished by the user authentication unit 106.

The selection screen on which a selected menu icon and others are arranged is explained below. It is assumed in the first embodiment that the selection screen includes four menu icons, namely, a menu icon “Home” that displays the Home screen, a menu icon “Jobs” that displays a Job screen, a menu icon “Functions” that displays a Function screen, and a menu icon “History” that displays a History screen.

As shown in FIG. 3, on the Home screen displayed on the LCD touch panel 220, menu icons 301, 302, 303, and 304 are arranged in a V-shaped formation, and a line image 307 of a solid line is arranged between the menu icons, consequently, the menu icons 301, 302, 303, and 304 are displayed such that the menu icons are connected to each other in the V-shaped formation. In addition, the menu icon 302 of “Home” is enlarged to be larger than the other menu icons, and displayed at the specified width position, thereby indicating that the menu icon 302 of “Home” is selected.

The specified width position is a position indicating that a menu icon at the position is selected, and positioned with a certain width from a certain side of the screen. Specifically, a position at a certain distance (width H) from the lower edge of the screen bottom in FIG. 3 is the specified width position. When any of the menu icons is selected, the display processing unit 101 shifts the selected menu icon downward on the screen such that the selected menu icon is arranged at the specified width position. Moreover, the display processing unit 101 rearranges the rest of the menu icons displayed on the LCD touch panel 220 other than the selected menu icon while maintaining the arrangement order with the selected menu icon. In other words, the display processing unit 101 shifts the selected menu icon to a position at the width H as the specified width position, so that the menu icons are rearranged in a V-shaped formation with the selected menu icon at a vertex as like the menu icon 302 is being pulled from the screen bottom, and the line image 307 is arranged between the four menu icons. The line image 307 is an image formed of a curve or a straight line to display a plurality of menu icons such that the menu icons are to be connected to each other in a V-shaped formation or a straight formation. The line image can be, for example, a solid line, a broken line, or an aggregation of points, as long as the image can connect the menu icons in a V-shaped formation or a straight formation. Although the line image 307 in the first embodiment is a solid line image, embodiments of the present invention are not limited to this. A case where menu icons are arranged in a straight formation will be explained later.

Additionally on the Home screen (selection screen), a borderline image 308 of a solid line is arranged below the menu icons 301, 302, 303, and 304, and further below, a group of sub-menu icons 305 that includes sub-menu icons and setting icons associated with the menu icon of “Home” is arranged and displayed in a lattice. The borderline image 308 is an image of a straight line that indicates a border of the menu icons from the sub-menu icons and the setting icons. The borderline image can be any of a solid line, a broken line, and an aggregation of points, as long as the image is arranged to indicate a border of menu icons from sub-menu icons and setting icons. The borderline image in the first embodiment is a solid line, with which it can be easily recognized that an area of the menu icons is divided from an area of the sub-menu icons. Alternatively, a border of menu icons from sub-menu icons and setting icons can be presented by coloring differently an area in which menu icons are arranged from an area in which sub-menu icons and setting icons are arranged. For example, it is possible to display in red the background of an arrangement area in which menu icons are arranged, while coloring in blue the background of the other arrangement area in which sub-menu icons and setting icons are arranged.

A scroll bar 306 is displayed on the right to the group of sub-menu icons 305. The scroll bar 306 enables the LCD touch panel 220 by scrolling to display sub-menu icons and setting icons that cannot be displayed on the LCD touch panel 220 all at once.

For example, when the user selects the menu icon 301 corresponding to the menu item of “Functions” on the Home screen shown in FIG. 3, a selection screen shown in FIG. 4 is displayed on the LCD touch panel 220.

As shown in FIG. 4, on the LCD touch panel 220, menu icons 701, 702, 703, and 704 are arranged in a straight formation, and a line image 707 of a solid line is arranged between the menu icons, consequently, the menu icons 701, 702, 703, and 704 are displayed such that the menu icons are connected to each other in the straight formation. In addition, the menu icon 701 of “Functions” is enlarged to be larger than the other menu icons, and shifted to and displayed at the specified width position, thereby indicating that the menu icon 701 of “Functions” is selected. As the menu icon 701 of “Functions” is selected, the menu icons are arranged in the straight formation as like the menu icon 701 of “Functions” is being pulled. In other words, the menu icons are arranged on a straight line right-upward on the screen in the order of the menu icon 701 of “Functions”, the menu icon 702 of “Home”, the menu icon 703 of “History”, and the menu icon 704 of “Jobs”. Additionally on the selection screen, a borderline image 708 of a solid line is arranged below the menu icons 701, 702, 703, and 704, and further below, a group of sub-menu icons 705 that includes sub-menu icons and setting icons associated with the menu icon of “Functions” is arranged in a lattice, and a scroll bar 706 is arranged on the right to the group of sub-menu icons 705.

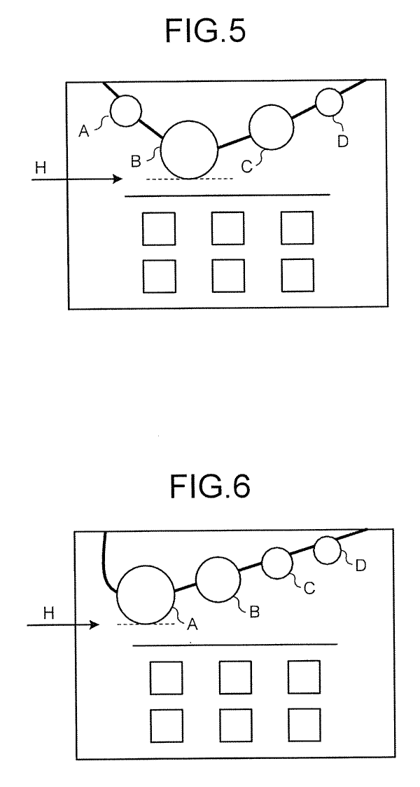

Relation between a selected menu icon and the other menu icons is explained below with reference to FIGS. 5 and 6. FIG. 5 depicts a state that four menu icons A, B, C, and D are displayed, and the menu icon B is selected. Therefore, the menu icon B is shifted to the specified width position (width H), and displayed larger than the other menu icons. In this case, the menu icon B looks as like being pulled downward, and the menu icons A, B, C, and D are displayed in a V-shaped formation as the menu icon B is arranged at a vertex, the menu icon A is arranged upper left to the vertex on the screen, and the menu icons C and D are arranged upper right to the vertex on the screen.

When the menu icon A is selected on the selection screen shown in FIG. 5, the menu icon A is shifted to the specified width position (width H) as shown in FIG. 6, and displayed larger than the other menu icons. In this case, the menu icon A looks as like being pulled downward, and the menu icons A, B, C, and D are displayed in a straight formation as the menu icon A is arranged at an end, and the menu icons B, C and D are arranged upward to the right of the screen.

When the menu icon C is selected, the menu icon C looks as like being pulled downward, and the menu icons A, B, C, and D are displayed in a V-shaped formation as the menu icon C is arranged at a vertex, the menu icons B and A are arranged upper left to the vertex on the screen, and the menu icon D is arranged upper right to the vertex on the screen. When the menu icon D is selected, the menu icon D looks as like being pulled downward, and the menu icons A, B, C, and D are displayed in a straight formation as the menu icon D is arranged at an end, and the menu icons C, B, and A are arranged upward to the left of the screen. In other words, a selected menu icon is shifted to the specified width position, while the other menu icons are also rearranged, as if the menu icons are connected to each other with an elastic string, and the selected menu icon is pulled.

The display processing unit 101 is configured to display and to switch the selection screen as explained above, and specifically performs the following processing. To display a selection screen on the LCD touch panel 220, when the user authentication unit 106 successfully finishes user authentication, the Home screen is displayed at first (see FIG. 3). In other words, the display processing unit 101 reads menu icon images, a display background image, a line image, and sub-menu icon images and setting icon images associated with the menu icon of “Home”, from the storage unit 104. The display background image is a screen that the menu icons, the sub-menu icons, and the line image are deleted from the selection screen. In other words, the display background image is a screen image on which only the borderline image 308 is drawn.

The display processing unit 101 then creates a selection screen by rearranging the read menu icon of “Home” to the specified width position, arranging the menu icons including the menu icon of “Home” in a V-shaped formation with the menu icon of “Home” positioned at a vertex in the upper part of the display background, arranging the line image 307 of a solid line between the menu icons, and furthermore arranging the read sub-menu icons and the read setting icons in a lattice in the lower part of the display background image below the menu icons and under the borderline image on-the display background, and displays the created selection screen on the LCD touch panel 220. By arranging the sub-menu icons and others below the menu icons in this way, it can be indicated that a relation between items corresponding to respective icons is a relation between an upper category and a lower category. To arrange the sub-menu icons and others in a lattice, for example, those can be arranged in a lattice inclined 45 degrees, or a checkerboard pattern, or a horizontal and vertical lattice. According to the first embodiment, by arranging the sub-menu icons and others in a horizontal and vertical lattice, appearance of the icons can be displayed in a simplified manner, and an area required for displaying can be reduced.

When displaying the created selection screen, the display processing unit 101 displays on the LCD touch panel 220 a menu icon to be arranged at the specified width position in response to reception of selection of the menu icon, i.e., the menu icon of “Home” in this case, by enlarging to a size in which the menu icon can be recognized at sight relatively to the other menu icons. The other menu icons than the selected menu icon can be displayed all in a certain size, or can be displayed such that the other menu icons are getting gradually smaller, as departing further from the selected menu icon.

Furthermore, the display processing unit 101 arranges in a lattice the sub-menu icons and the setting icons associated with the read and selected menu icon below the menu icons on the display background image. The display processing unit 101 then displays the display background on which the menu icons, the sub-menu icons, and the setting icons are arranged onto the LCD touch panel 220 as a selection screen.

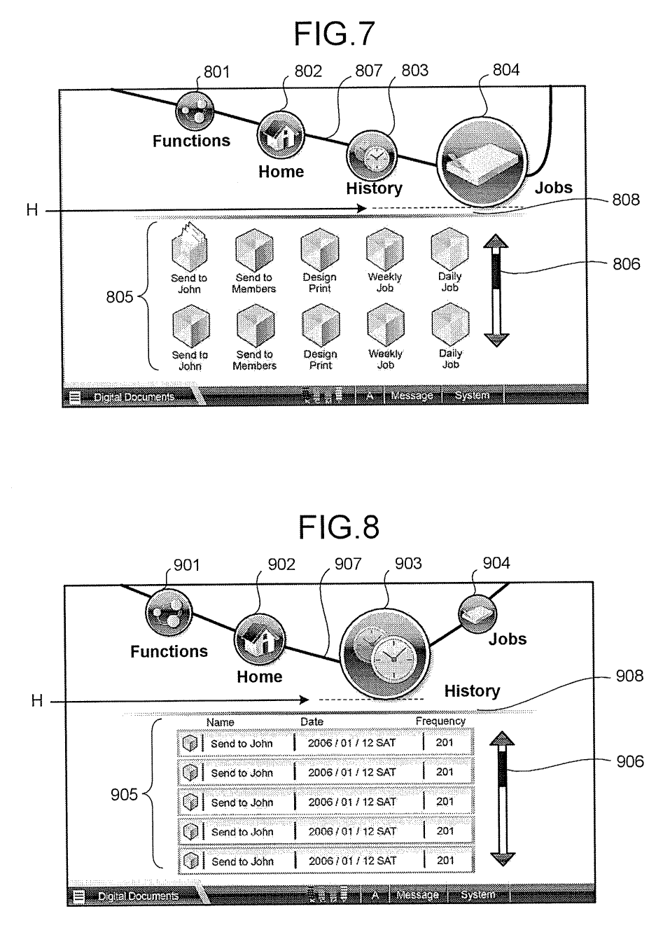

A selection screen when another menu icon is selected is explained below. FIG. 7 depicts a case where the menu icon of “Jobs” is selected on the Home screen shown in FIG. 3. As shown in FIG. 7, on the LCD touch panel 220, menu icons 801, 802, 803, and 804 are arranged in a straight formation on the display background, and a line image 807 of a solid line is arranged between the menu icons, consequently, the menu icons 801, 802, 803, and 804 are displayed such that the menu icons are connected to each other in the straight formation. In addition, the menu icon 804 of “Jobs” is enlarged to be larger than the other menu icons, and displayed at the specified width position, thereby indicating that the menu icon 804 of “Jobs” is selected. The display processing unit 101 rearranges the menu icons in the straight formation extending left-upward from the menu icon 804 of “Jobs” in the order of the menu icon 803 of “History”, the menu icon 802 of “Home”, and the menu icon 801 of “Functions” as like the menu icon 804 of “Jobs” shifted to the position at the width H is being pulled from the screen bottom, and the line image 807 is arranged between the four menu icons. Additionally on the selection screen, a borderline image 808 of a solid line is arranged below the menu icons 801, 802, 803, and 804, and further below, a group of sub-menu icons 805 that includes sub-menu icons and setting icons associated with the menu icon of “Jobs” is arranged in a lattice, and a scroll bar 806 is arranged on the right to the group of sub-menu icons 805.

A selection screen when still another menu icon is selected is explained below. FIG. 8 depicts a case where the menu icon of “History” is selected on the Home screen shown in FIG. 3. As shown in FIG. 8, on the LCD touch panel 220, menu icons 901, 902, 903, and 904 are arranged in a V-shaped formation on a display background, and a line image 907 of a solid line is arranged between the menu icons, consequently, the menu icons 901, 902, 903, and 904 are displayed such that the menu icons are connected to each other in the V-shaped formation. In addition, the menu icon 903 of “History” is enlarged to be larger than the other menu icons, and displayed at the specified width position, thereby indicating that the menu icon 903 of “History” is selected. The display processing unit 101 rearranges the menu icons into the V-shaped formation with the menu icon 903 of “History” at a vertex as like the menu icon 903 of “History” shifted to the position at the width H is being pulled from the screen bottom, and the line image 907 is arranged between the four menu icons. Additionally on the selection screen, a borderline image 908 of a solid line is arranged below the menu icons 901, 902, 903, and 904, and further below, a history (sub-menu icons) 905 of the MFP 100 associated with the menu icon of “History” is arranged and displayed, and a scroll bar 906 is arranged on the right to the history 905.

The selection receiving unit 103 receives a selection of a menu icon of a menu desired by the user from among the menu icons displayed on the selection screen by the display processing unit 101. Specifically, when the user presses a menu item displayed by the display processing unit 101 on the LCD touch panel 220, the selection receiving unit 103 receives a selection that the pressed menu item is selected. Moreover, the selection receiving unit 103 receives input from various buttons, such as the initial setting key 201.

The execution processing unit 105 includes an input processing unit 111 and an output processing unit 112, and executes input and output by using functions included in the MFP 100. Processing by using hardware is then performed as control units included in the service layer 152 control hardware resources based on contents processed by the execution processing unit 105.

The input processing unit 111 processes input of image data using an input function corresponding to a setting icon associated with a menu icon of which selection is received by the selection receiving unit 103. For example, when the selection receiving unit 103 receives a selection of the setting icon “Design Print”, the input processing unit 111 controls a not-shown scanner with the scanner control unit 121, and reads paper document.

The output processing unit 112 processes of output of image data using an output function corresponding to the setting icon associated with a menu icon of which selection is received by the selection receiving unit 103. For example, when the selection receiving unit 103 receives a selection of the setting icon “Design Print”, the output processing unit 112 controls a not-shown plotter with the plotter control unit 122, and controls a printing process for paper document.

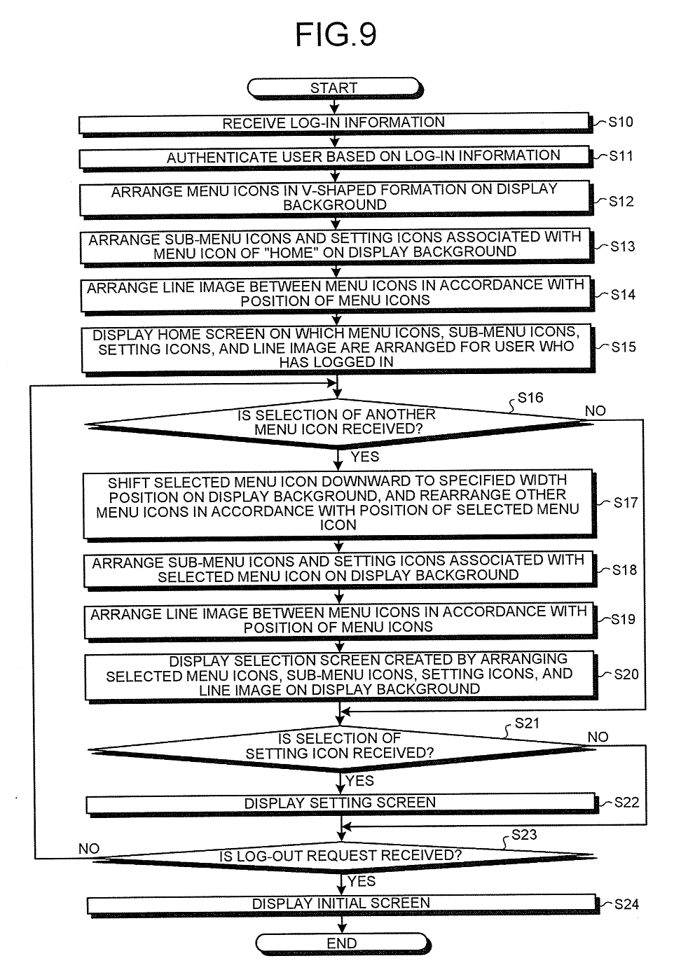

Display processing performed by the MFP 100 according to the first embodiment configured as described above is explained below with reference to FIG. 9.

First of all, the selection receiving unit 103 receives log-in information input by a user (Step S10). Specifically, the selection receiving unit 103 receives a user name and a password as the log-in information, which are input on a log-in screen. The log-in screen is a screen configured to be displayed, for example, when the user selects a button for log-in displayed on an initial screen.

Then, the user authentication unit 106 performs user authentication based on the log-in information received by the selection receiving unit 103 (Step S11). When the user authentication is successfully finished, the display processing unit 101 reads a display background image, a line image, menu icon images, and sub-menu icon images and setting icon images associated with the menu icon of “Home”, from the storage unit 104 to display a Home screen for the user. The display processing unit 101 arranges the menu icons in a V-shaped formation on the read display background (Step S12). The display processing unit 101 arranges sub-menu icons and setting icons associated with the menu icon of “Home” in a lattice below the menu icons on the display background (Step S13). The display processing unit 101 arranges the line image between the menu icons to connect the menu icons in a V-shaped formation in accordance with a position of each of the menu icons (Step S14). The display processing unit 101 then displays on the LCD touch panel 220 a Home screen for the user who has logged in created by arranging the menu icons, the sub-menu icons, the setting icons, and the line image (Step S15). Such Home screen is the Home screen shown in FIG. 3.

Then, the selection receiving unit 103 determines whether a selection of another menu icon is received (Step S16). The selection screen to be displayed in accordance with another menu icon is one of the Job screen that displays thereon jobs each of which defines regular processing, the Function screen that displays individual functions of the MFP 100, such as photocopying and facsimile transmission, the History screen that displays a history of processing, and the like.

If the selection of another menu icon is received (Yes at Step S16), the display processing unit 101 shifts the selected menu icon downward to the specified width position on the display background, rearranges the other menu icons in accordance with the position of the selected menu icon, and arranges the menu icons in a V-shaped formation or a straight formation (Step S17). The display processing unit 101 then reads sub-menu icon images and setting icon images associated with the selected menu icon, and a line image from the storage unit 104. The display processing unit 101 arranges the sub-menu icons and the setting icons associated with the selected menu icon below the menu icons on the display background (Step S18). The display processing unit 101 arranges the line image between the menu icons to connect the menu icons in a V-shaped formation or a straight formation in accordance with a position of the selected menu icon (Step S19). The display processing unit 101 then displays on the LCD touch panel 220 a selection screen created by arranging the menu icons, the sub-menu icons and the setting icons, and the line image on the display background (Step S20). Such displayed selection screen (changed selection screen) can be the selection screen shown in FIG. 4, 7, or 8.

By contrast, returning to Step S16, if selection of another menu icon is not received (No at Step S16), none of the other selection screens is displayed and the process control goes to Step S21.

Then, it is determined whether a selection of a setting icon is received from the selection screen (Step S21). If the selection of a setting icon is received (Yes at Step S21), the display processing unit 101 displays a setting screen corresponding to the setting icon onto the LCD touch panel 220 (Step S22). Various settings are to be performed from the displayed setting screen. By contrast, if the selection of a setting icon is not received (No at Step S21), the processing at Step S22 is not to be performed. Moreover, if any setting icon is not displayed on the selection screen displayed by the display processing unit 101, the processing at Step S22 is not to be performed.

The selection receiving unit 103 then determines whether a log-out request is received (Step S23). The log-out request is to be received, for example, when a button for log-out displayed in a lower part of the screen is selected.

If the log-out request is not received (No at Step S23), the process control goes back to the selection receiving process to receive another menu icon and repeats the processing (Step S16). By contrast, if the log-out request is received (Yes at Step S23), the display processing unit 101 displays the initial screen before the log-in (Step S24).

Thus, according to the first embodiment, the menu icons are rearranged while the arrangement order is maintained, so that contents of the menu icons displayed on a selection screen are easily grasped, and a position of a desired menu icon can be easily recognized. Moreover, sub-menu icons and setting icons associated with a selected menu icon are arranged and displayed in a lattice, so that an operational performance of processing of setting functional conditions can be improved.

According to a second embodiment of the present invention, sub-menu icons and others associated with each of not-selected menu icons are additionally displayed in a reduced size in the vicinity of the associated not-selected menu icon.

The configuration of a MFP according to the second embodiment is similar to the first embodiment, therefore, a function different from the first embodiment is explained with reference to FIG. 1.

In addition to the functions of the display processing unit 101 according to the first embodiment, the display processing unit 101 is configured to display a selection screen on which the display processing unit 101 arranges sub-menu icons and setting icons associated with each of menu icons other than a selected menu icon in a reduced size in the vicinity of each associated menu icon.

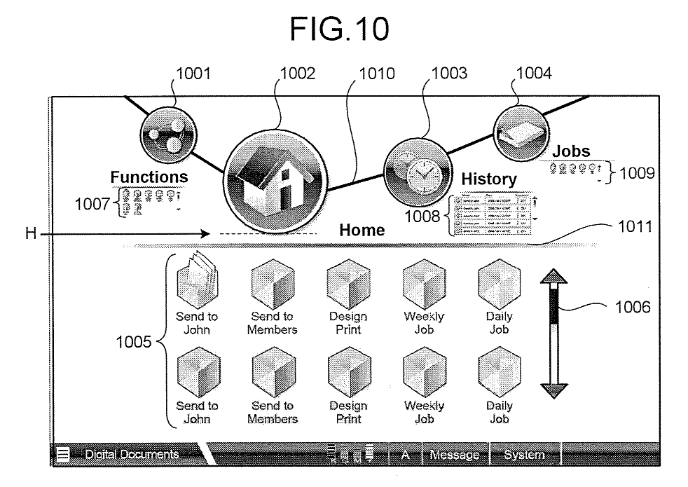

As shown in FIG. 10, on the Home screen displayed on the LCD touch panel 220, similarly to FIG. 3, menu icons 1001, 1002, 1003, and 1004 are arranged in a V-shaped formation, and a line image 1010 of a solid line is arranged between the menu icons, consequently, the menu icons 1001, 1002, 1003, and 1004 are displayed such that the menu icons are connected to each other in the V-shaped formation. In addition, the menu icon 1002 of “Home” is enlarged to be larger than the other menu icons, and displayed at the specified width position, thereby indicating that the menu icon 1002 of “Home” is selected.

Additionally on the Home screen (selection screen), a borderline image 1011 of a solid line is arranged below the menu icons 1001, 1002, 1003, and 1004, and further below, a group of sub-menu icons 1005 that includes sub-menu icons and setting icons associated with the menu icon of “Home” is arranged and displayed in a lattice. A scroll bar 1006 is displayed on the right to the group of sub-menu icons 1005. The scroll bar 1006 enables the LCD touch panel 220 by scrolling to display sub-menu icons and setting icons that cannot be displayed on the LCD touch panel 220 all at once.

According to the second embodiment, groups of reduced sub-menu icons 1007, 1008, and 1009, are additionally arranged and displayed in the vicinity of respective menu icons other than the menu icon of “Home”. Each of the groups of reduced sub-menu icons 1007, 1008, and 1009 includes sub-menu icons and setting icons in a reduced size associated with one of the menu icons other than the menu icon of “Home”. According to the second embodiment, when a user selects one of the menu icons, the display processing unit 101 displays one of such selection screens by switching.

Specifically, the display processing unit 101 performs the following processing. When the user authentication unit 106 successfully finishes user authentication, the display processing unit 101 reads from the storage unit 104 menu icon images, a display background image, a line image, sub-menu icon images and setting icon images associated with the menu icon of “Home”, and sub-menu icon images and setting icon images associated with the rest of the menu icons displayed on the Home screen other than the menu icon of “Home”. The display processing unit 101 then creates a selection screen by rearranging the read menu icon of “Home” to the specified width position, arranging the menu icons including the menu icon of “Home” in a V-shaped formation with the menu icon of “Home” positioned at a vertex in the upper part of the display background, arranging the line image 1010 of a solid line between the menu icons, arranging the read sub-menu icons and the read setting icons associated with the menu icon of “Home” in a lattice in the lower part of the display background image below the menu icons and under the borderline image on the display background, and furthermore arranging read sub-menu icons and read setting icons associated with each of the menu icons other than the menu icon of “Home” in a reduced size in the vicinity of the associated menu icons, and displays the created selection screen on the LCD touch panel 220. When displaying the created selection screen, the display processing unit 101 displays on the LCD touch panel.220 a menu icon to be arranged at the specified width position in response to reception of selection of the menu icon, i.e., the menu icon of “Home” in this case, by enlarging to a size in which the menu icon can be recognized at sight relatively to the other menu icons. Moreover, even when one of the menu icons other than the menu icon of “Home” is selected, the display processing unit 101 similarly displays sub-menu icons and setting icons in a reduced size in the vicinity of respective associated menu icons other than the selected menu icon.

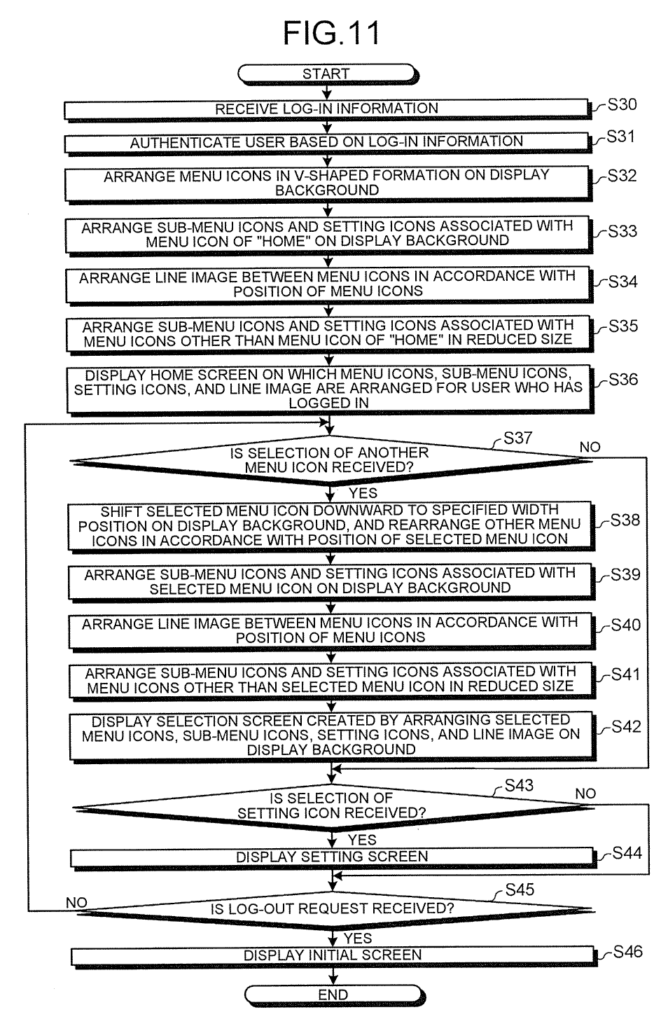

Display processing performed by the MFP 100 according to the second embodiment configured as described above is explained below with reference to FIG. 11.

First of all, processes from reception of log-in information from a user to user authentication (Steps S30 and S31) are similar to those (Steps S10 and S11) shown in FIG. 9 in the first embodiment, therefore, explanations of them are omitted.

When the user authentication is successfully finished, the display processing unit 101 reads a display background image, a line image, menu icon images, sub-menu icon images and setting icon images associated with the menu icon of “Home”, and sub-menu icon images and setting icon images associated with the rest of the menu icons other than the menu icon of “Home”, from the storage unit 104 to display a Home screen for the user. The display processing unit 101 arranges the menu icons in a V-shaped formation on the read display background (Step S32). The display processing unit 101 arranges sub-menu icons and setting icons associated with the menu icon of “Home” in a lattice below the menu icons on the display background (Step S33). The display processing unit 101 arranges the line image between the menu icons to connect the menu icons in a V-shaped formation in accordance with a position of each of the menu icons (Step S34). Additionally, the display processing unit 101 arranges sub-menu icons and setting icons associated with each of the menu icons other than the menu icon of “Home” in a reduced size in the vicinity of each associated menu icon other than the menu icon of “Home” (Step S35). The display processing unit 101 then displays on the LCD touch panel 220 the Home screen for the user who logs in created by arranging the menu icons, the sub-menu icons and the setting icons, and the line image (Step S36). Such Home screen is the Home screen shown in FIG. 10.

Then, the selection receiving unit 103 determines whether a selection of another menu icon is received (Step S37). If the selection of another menu icon is received (Yes at Step S37), the display processing unit 101 shifts the selected menu icon downward to the specified width position on the display background, and rearranges the other menu icons in accordance with the position of the selected menu icon, and arranges the menu icons (Step S38). The display processing unit 101 then reads sub-menu icon images and setting icon images associated with the selected menu icon, sub-menu icon images and setting icon images associated with the rest of the menu icons other than the selected menu icon, and a line image from the storage unit 104. The display processing unit 101 arranges the sub-menu icons and the setting icons associated with the selected menu icon below the menu icons on the display background (Step S39). The display processing unit 101 arranges the line image between the menu icons to connect the menu icons in a V-shaped formation or a straight formation in accordance with a position of the selected menu icon (Step S40). Moreover, the display processing unit 101 arranges into a reduced size read sub-menu icons and read setting icons associated with each of the menu icons other than the selected menu icon in the vicinity of each associated menu icon other than the selected menu icon (Step S41). The display processing unit 101 then displays on the LCD touch panel 220 a selection screen created by arranging the menu icons, the sub-menu icons and the setting icons, and the line image on the display background (Step S42).

By contrast, returning to Step S37, if selection of another menu icon is not received (No at Step S37), none of the other selection screens is displayed and the process control goes to Step S43. Then, processes from selection of a setting icon to display of the initial screen (Steps S43 to S46) are similar to those (Steps S21 to S24) shown in FIG. 9 in the first embodiment, therefore, explanations of them are omitted.

Thus, according to the second embodiment, the menu icons are rearranged while the arrangement order is maintained, so that contents of the menu icons displayed on a selection screen are easily grasped, and a position of a desired menu icon can be easily recognized. Moreover, sub-menu icons and setting icons associated with a selected menu icon are arranged and displayed in a lattice, so that an operational performance of processing of setting functional conditions can be improved. Furthermore, the sub-menu icons and the setting icons associated with the menu icons other than the selected menu icon are also displayed, so that contents of sub-menu items and setting items belonging to not-selected menu items are easily recognized, accordingly the operational performance can be further improved.

Although according to the first and second embodiments, the display processing unit 101 displays the icons into upper and lower parts by arranging the menu icons in the upper part, and the sub-menu icons and others below the menu icons, embodiments of the present invention are not limited to this. According to a third embodiment of the present invention, the display processing unit 101 can display icons into right and left sides by arranging the menu icons on the left side, and sub-menu icons and others on the right to the menu icons. Aspects apart from arrangements of menu icons and sub-menu icons are similar to those in the first embodiment, therefore, explanations of them are omitted in the third embodiment.

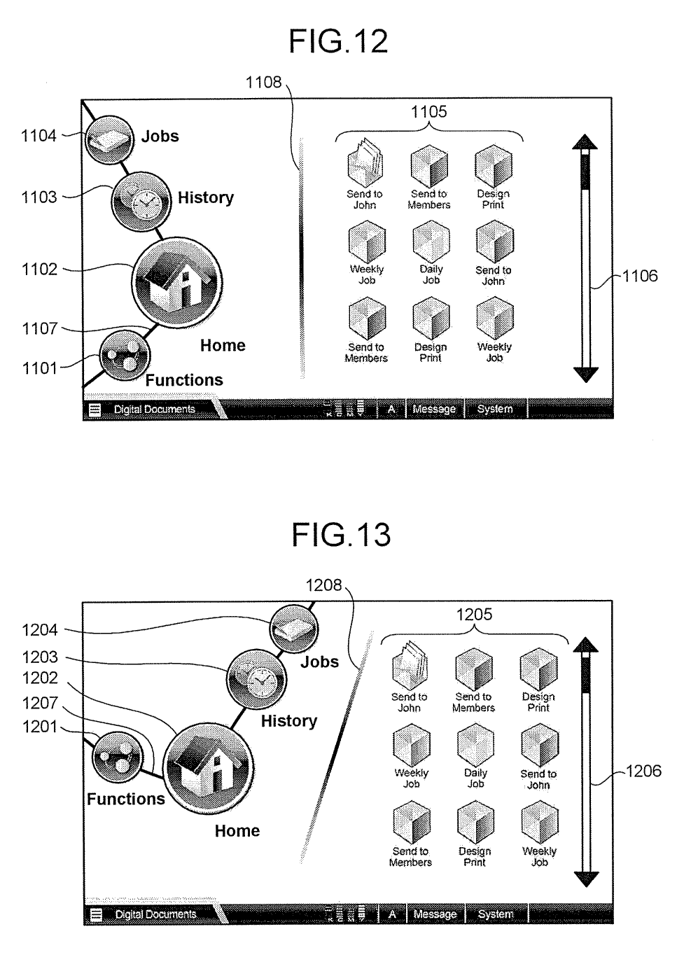

As shown in FIG. 12, on the Home screen displayed on the LCD touch panel 220, menu icons 1101, 1102, 1103, and 1104 are arranged in a sideways V-shaped formation on the left side of the screen, and a line image 1107 of a solid line is arranged between the menu icons, consequently, the menu icons 1101, 1102, 1103, and 1104 are displayed such that the menu icons are connected to each other in the sideways V-shaped formation. In addition, the menu icon 1102 of “Home” is enlarged and displayed to be larger than the other menu icons, thereby indicating that the menu icon 1102 of “Home” is selected.

Moreover, the display processing unit 101 rearranges the rest of the menu icons displayed on the LCD touch panel 220 other than the selected menu icon while maintaining the arrangement order with the selected menu icon. Specifically, the display processing unit 101 rearranges the menu icons to be arranged in a sideways V-shaped formation with the selected menu icon at a vertex as like the menu icon 1102 that is selected is being pulled from the screen right side, and the line image 1107 is arranged between the four menu icons. Similarly to the first and second embodiments, the line image 1107 is an image formed of a curve or a straight line to display a plurality of menu icons such that the menu icons are to be connected to each other in a sideways V-shaped formation or a straight formation.

Additionally on the Home screen (selection screen), a borderline image 1108 of a solid line is arranged on the right to the menu icons 1101, 1102, 1103, and 1104, and on the further right side, a group of sub-menu icons 1105 that includes sub-menu icons and setting icons associated with the menu icon of “Home” is arranged and displayed in a lattice. Similarly to the first and second embodiments, the borderline image 1108 is an image of a straight line that indicates a border of the menu icons from the sub-menu icons and the setting icons.

A scroll bar 1106 is displayed on the right to the group of sub-menu icons 1105. The scroll bar 1006 enables the LCD touch panel 220 by scrolling to display sub-menu icons and setting icons that cannot be displayed on the LCD touch panel 220 all at once.

Thus, according to the third embodiment, the menu icons are rearranged while the arrangement order is maintained, so that contents of the menu icons displayed on a selection screen are easily grasped, and a position of a desired menu icon can be easily recognized. Moreover, sub-menu icons and setting icons associated with a selected menu icon are arranged and displayed in a lattice, so that an operational performance of processing of setting functional conditions can be improved.

According to a fourth embodiment of the present invention, the display processing unit 101 can display icons on a slant by arranging the menu icons in the upper left, and the sub-menu icons and others in the lower right of the menu icons. Aspects apart from arrangements of menu icons and sub-menu icons are similar to those in the first embodiment, therefore, explanations of them are omitted in the fourth embodiment.

As shown in FIG. 13, on the Home screen displayed on the LCD touch panel 220, menu icons 1201, 1202, 1203, and 1204 are arranged in a V-shaped formation on the upper left of the screen, and a line image 1207 of a solid line is arranged between the menu icons, consequently, the menu icons 1201, 1202, 1203, and 1204 are displayed such that the menu icons are connected to each other in the V-shaped formation. In addition, the menu icon 1202 of “Home” is enlarged and displayed to be larger than the other menu icons, thereby indicating that the menu icon 1202 of “Home” is selected.

Moreover, the display processing unit 101 rearranges the rest of the menu icons displayed on the LCD touch panel 220 other than the selected menu icon while maintaining the arrangement order with the selected menu icon. Specifically, the display processing unit 101 rearranges the menu icons into a V-shaped formation with the selected menu icon at a vertex as like the menu icon 1202 that is selected is being pulled from the screen lower-right side, and the line image 1207 is arranged between the four menu icons. Similarly to the first and second embodiments, the line image 1207 is an image formed of a curve or a straight line to display a plurality of menu icons such that the menu icons are connected to each other in a sideways V-shaped formation or a straight formation.

Additionally on the Home screen (selection screen), a borderline image 1208 of a solid line is arranged lower right to the menu icons 1201, 1202, 1203, and 1204, and further lower-right, a group of sub-menu icons 1205 that includes sub-menu icons and setting icons associated with the menu icon of “Home” is arranged and displayed in a lattice. Similarly to the first and second embodiments, the borderline image 1208 is an image of a straight line that indicates a border of the menu icons from the sub-menu icons and the setting icons.

A scroll bar 1206 is displayed on the right to the group of sub-menu icons 1205. The scroll bar 1206 enables the LCD touch panel 220 by scrolling to display sub-menu icons and setting icons that cannot be displayed on the LCD touch panel 220 all at once.

Thus, according to the fourth embodiment, the menu icons are rearranged while the arrangement order is maintained, so that contents of the menu icons displayed on a selection screen are easily grasped, and a position of a desired menu icon can be easily recognized. Moreover, sub-menu icons and setting icons associated with a selected menu icon are arranged and displayed in a lattice, so that an operational performance of processing of setting functional conditions can be improved.

According to a fifth embodiment of the present invention, the display processing unit 101 can form a display area of the menu icons (hereinafter, “menu icon area”) and a display area of the sub-menu icons (hereinafter, “sub-menu icon area”) into separate screens, and can arrange the screen of the menu icon area behind the screen of the sub-menu icon area in an overlapping manner, so that the menu icon area and the sub-menu icon area can be displayed in the front and the back in an overlapping manner. Aspects apart from arrangements of menu icons and sub-menu icons are similar to those in the first embodiment, therefore, explanations of them are omitted in the fifth embodiment.

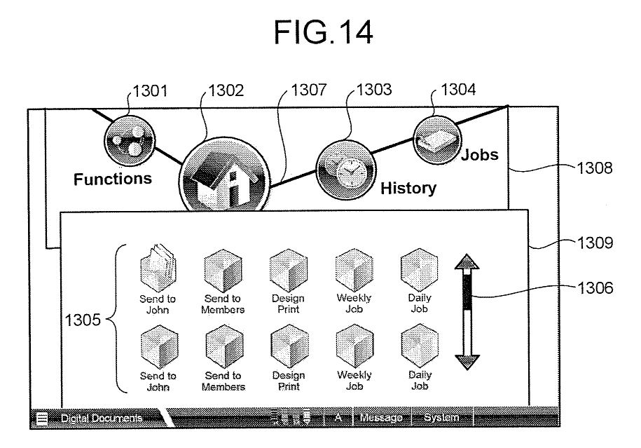

As shown in FIG. 14, a menu icon area 1308 and a sub-menu icon area 1309 are displayed on the Home screen displayed on the LCD touch panel 220 in an overlapping manner such that the menu icon area 1308 appears behind the sub-menu icon area 1309. In the menu icon area 1308, menu icons 1301, 1302, 1303, and 1304 are arranged in a V-shaped formation, and a line image 1307 of a solid line is arranged between the menu icons, consequently, the menu icons 1301, 1302, 1303, and 1304 are displayed such that the menu icons are connected to each other in the V-shaped formation, and displayed in an upper back of the screen. In addition, the menu icon 1302 of “Home” is enlarged and displayed to be larger than the other menu icons, thereby indicating that the menu icon 1302 of “Home” is selected. In the sub-menu icon area 1309, sub-menu icons and a scroll bar 1306 is displayed.

Moreover, the display processing unit 101 rearranges the rest of the menu icons displayed on the LCD touch panel 220 other than the selected menu icon while maintaining the arrangement order with the selected menu icon. Specifically, the display processing unit 101 rearranges the menu icons into a V-shaped formation with the selected menu icon at a vertex as like the menu icon 1302 that is selected is being pulled from the screen bottom, and the line image 1307 is arranged between the four menu icons. Similarly to the first and second embodiments, the line image 1307 is an image formed of a curve or a straight line to display a plurality of menu icons such that the menu icons are connected to each other in a V-shaped formation or a straight formation.

A group of sub-menu icons 1305 of sub-menu icons and setting icons associated with the menu icon of “Home” is arranged in a lattice and displayed in the sub-menu icon area 1309 on the Home screen, and the sub-menu icon area 1309 is displayed in the front in a lower part of the screen to overlap partially with the menu icon 1302 in the menu-icon area 1308. The scroll bar 1306 is displayed on the right to the group of sub-menu icons 1305. The scroll bar 1306 enables the LCD touch panel 220 by scrolling to display sub-menu icons and setting icons that cannot be displayed on the LCD touch panel 220 all at once.

Thus, according to the fifth embodiment, the menu icons are rearranged while the arrangement order is maintained, so that contents of the menu icons displayed in the menu-icon area 1308 on a selection screen are easily grasped, and a position of a desired menu icon can be easily recognized. Moreover, sub-menu icons and setting icons associated with the selected menu icon are arranged and displayed in a lattice in the sub-menu icon area 1309, so that an operational performance of processing of setting functional conditions can be improved.

Although the display processing unit 101 arranges and displays a line image between the menu icons according to the first to fifth embodiments, it can be configured such that the menu icons are arranged on a line image or in the vicinity of a line image.

Although according to the first to fifth embodiments, the display processing unit 101 creates a selection screen on which menu icons, sub-menu icons, and the like are arranged on a display background when displaying a selection screen, and then displays the created selection screen onto the LCD touch panel 220, embodiments of the present invention are not limited to this. For example, it can be configured such that images of selection screens different from each other in arrangements of menu icons are prepared and stored in the storage unit 104 in advance as many as the menu icons, and when the user selects a menu icon, the display processing unit 101 reads from the storage unit 104 a selection screen on which the selected menu icon is arranged at the specified width position in an enlarged size, and displays the read selection screen onto the LCD touch panel 220 without rearranging relevant icons on the display background. In such case, the display processing unit 101 does not need to perform processing of arranging the icons onto the display background, thereby achieving faster display processing. Alternatively, it can be configured such that the storage unit 104 stores therein in advance screen images in process of rearrangement until a selected menu icon is shifted to the specified width position, and the display processing unit 101 displays the menu icon as like being moved by displaying the stored screen images continuously when the menu icon is selected.

Although according to the first and second embodiments, the display processing unit 101 displays the selected menu icon at the specified width position in an enlarged size, embodiments of the present invention are not limited to this, but also it can be configured such that the selected menu icon is only shifted to the specified width position without enlarged display.

Although according to the first to fifth embodiments, the display processing unit 101 forms each of the menu icons in circle, and makes each of the menu items distinguishable by adding an illustration of the menu item into the circle, embodiments of the present invention are not limited to this, but also other shapes or other illustrations can be a menu icons. For example, it can be designed to identify the menu icons by using menu icons in various shapes, such as a star and a diamond, menu icons of various material patterns, such as wood grain, textile, and metal, menu icons in various colors, such as red, blue, and yellow.

Although the display processing apparatus is applied to a MFP in the examples described in the first to fifth embodiments, the present invention is not limited to this, but also can be applied to any device that can display certain information. The display processing apparatus according the embodiments of the present invention can be applied to, for example, a photocopier that prints data, a facsimile, a personal computer (PC), a car navigation system that displays a current position of a car or a route to a specified destination.

When the display processing apparatus is applied to a photocopier, a facsimile, or a car navigation system, it can be configured such that menus or others displayed on a screen for setting functional conditions are arranged in a V-shaped formation or a straight formation similarly to the embodiments, and a selection or other input is received via a liquid crystal display touch panel. When the display processing apparatus is applied to a PC that does not includes a display unit configured to receive input from a user via a display screen, such as a liquid crystal display touch panel, it can be configured such that menus or others displayed on the screen for setting functional conditions are arranged in a V-shaped formation or a straight formation similarly to the embodiments, and a selection or other input is received via input from an input device, such as a mouse.

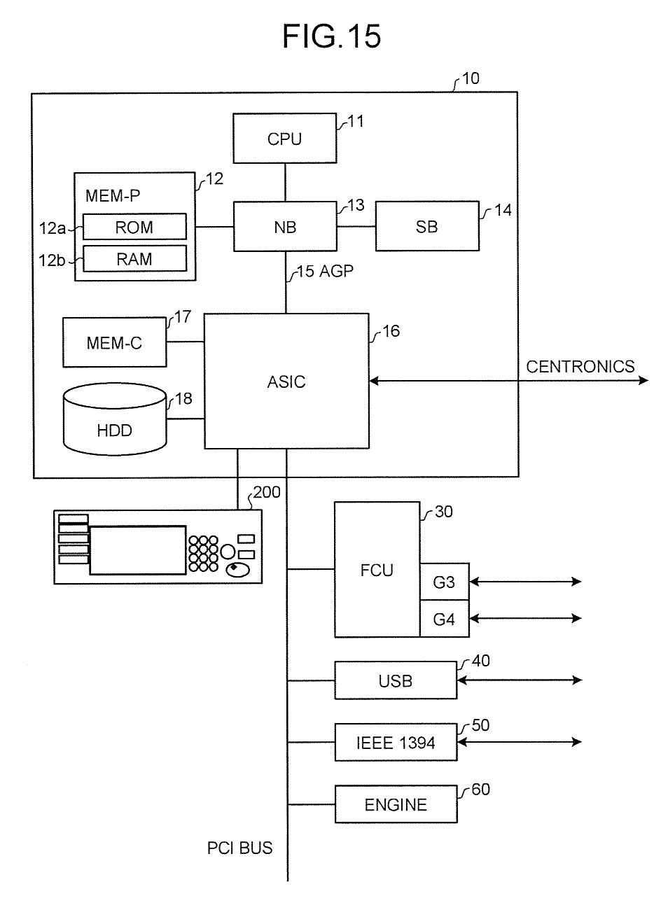

As shown in FIG. 15, the MFP 100 according to the first to fifth embodiments has a hardware configuration in which a controller 10 is connected to an engine unit 60 with a peripheral component interconnect (PCI) bus. The controller 10 controls the total control of the MFP 100, drawing, transmission, and input from the operation panel 200. The engine unit 60 is a printer engine that can be connected to a PCI bus, for example, a monochrome plotter, a single-drum color plotter, a four-drum color plotter, a scanner, or a facsimile unit. In addition to a typical engine function, such as a plotter, the engine unit 60 includes image processing functions, such as error diffusion and gamma correction.

The controller 10 includes a central processing unit (CPU) 11, a north bridge (NB) 13, a system memory (MEM-P) 12, a south bridge (SB) 14, a local memory (MEM-C) 17, an application specific integrated circuit (ASIC) 16, and a hard disk drive (HDD) 18, and an accelerated graphics port (AGP) bus 15 connects between the NB 13 and the ASIC 16. The MEM-P 12 further includes a read-only memory (ROM) 12a and a random access memory (RAM) 12b.

The CPU 11 performs the total control of the MFP 100, includes a chip set that includes the NB 13, the MEM-P 12, and the SB 14, and is connected to other devices via the chip set.

The NB 13 is a bridge to connect the CPU 11 to the MEM-P 12, the SB 14, and the AGP bus 15, and includes a memory controller that controls reading from and writing onto the MEM-P 12, a PCI master, and an AGP target.

The MEM-P 12 is a system memory to be used as a storage memory for programs and data, a development memory for programs and data, a drawing memory of a printer, and the like, and includes the ROM 12a and the RAM 12b. The ROM 12a is a read only memory to be used as a storage memory for programs and data. The RAM 12b is a writable and readable memory to be used as a development memory for programs and data, a drawing memory of a printer, and the like.

The SB 14 is a bridge to connect the NB 13 to a PCI device, and peripheral device. The SB 14 is connected to the NB 13 via the PCI bus, and also a network interface is connected to the PCI bus.

The ASIC 16 is an integrated circuit (IC) that has a hardware factor for image processing and is configured to be used for image processing, and has a role of a bridge to connect the AGP bus 15, the PCI bus, the HDD 18, and the MEM-C 17 one another. The ASIC 16 includes the PCI target and the AGP master, an arbiter (ARB) that is a core of the ASIC 16, a memory controller that controls the MEM-C 17, a plurality of direct memory access controllers that processes image data, for example, turning image data, with hardware logic, and a PCI unit that performs data transfer to the engine unit 60 via the PCI bus. A fax control unit (FCU) 30, a universal serial bus (USB) 40, and an Institute of Electrical and Electronics Engineers 1394 (IEEE 1394) interface 50 are connected to the ASIC 16 via the PCI bus.

The MEM-C 17 is a local memory to be used as an image buffer for copying and a code buffer. The HDD 18 is a storage that stores therein image data, programs, font data, and forms.

The AGP bus 15 is a bus interface for a graphic accelerator card proposed to speed up graphic processing, and is configured to speed up the performance of a graphic accelerator card by directly accessing the MEM-P 12 at a high throughput.

A display processing program to be executed by the display processing apparatus described in the embodiments can be provided by being incorporated in a ROM in advance.

Moreover, the display processing program can be provided in a file of an installable format or an executable format by being recorded in a computer readable recording medium, such as a compact disk read only memory (CD-ROM), a flexible disk (FD), or a digital versatile disk (DVD).

Furthermore, the display processing program can be stored in a computer connected to a network, such as the Internet, and provided by downloading via the network. Alternatively, the display processing program can be provided or distributed via a network, such as the Internet.

The display processing program has a module configuration that includes the above described units (the display processing unit, the selection receiving unit, and the user authentication unit), each of which is configured to be loaded on a main memory and created as actual hardware on the main memory by reading the display processing program from the ROM by the CPU.

As described above, according to an aspect of the present invention, the upper item symbols are arranged and displayed on the display unit, and when a selection of one of the upper item symbol is received, the display unit displays thereon a changed selection screen on which the selected upper item symbol is shifted to a specified width position, which is a predetermined width in a certain distance from a certain side of the screen and indicates that a symbol at the position is selected, and the other displayed upper item symbols are rearranged while the arrangement order of the upper item symbols is maintained. Accordingly, contents of setting items are easily recognized, and a position of a desired menu item can be easily grasped.

Furthermore, according to another aspect of the present invention, because lower item symbols associated with an upper item symbol are arranged and displayed in a lattice, an operational performance of processing of setting functional conditions can be improved.

Moreover, according to still another aspect of the present invention, because lower item symbols associated with each of upper item symbols other than a selected upper item symbol are arranged in a reduced size, contents of the lower setting items belonging to not-selected upper setting items can be easily recognized, accordingly an operational performance can be further improved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A display processing apparatus comprising:
a display processing unit that displays on a display unit a first selection screen on which a plurality of upper item symbols corresponding to respective upper setting items are arranged; and
a selection receiving unit that receives a selection of an upper item symbol, wherein
when the selection of the upper item symbol is received, the display processing unit shifts a selected upper item symbol to a specified width position with a predetermined width in a predetermined distance from one side of a screen, and displays on the display unit a second selection screen on which other displayed upper item symbols are rearranged with an arrangement order unchanged.

2. The display processing apparatus according to claim 1, wherein the display processing unit displays the second selection screen on which the selected upper item symbol is enlarged.

3. The display processing apparatus according to claim 1, wherein the display processing unit displays on the display unit the second selection screen on which a lower item symbol corresponding to a lower setting item belonging to an upper setting item corresponding to the selected upper item symbol is further arranged.

4. The display processing apparatus according to claim 3, wherein the display processing unit displays on the display unit the second selection screen on which a plurality of lower item symbols are arranged in a lattice.

5. The display processing apparatus according to claim 4, wherein the display processing unit displays on the display unit the second selection screen on which the lower item symbols are arranged below the upper item symbols.

6. The display processing apparatus according to claim 1, wherein the display processing unit displays on the display unit the second selection screen on which a line image connecting the upper item symbols is arranged between each of the upper item symbols.

7. The display processing apparatus according to claim 3, wherein the display processing unit displays the second selection screen on which lower item symbols associated with each of the upper item symbols other than the selected upper item symbol are arranged in a reduced size in vicinity of each of the upper item symbols.

8. The display processing apparatus according to claim 7, further comprising a storage unit that stores therein the upper item symbols and a display background that includes an area in which the upper item symbols can be arranged, wherein
the display processing unit reads the upper item symbols and the display background from the storage unit, creates the selection screen on which read upper item symbols are arranged on the display background, and displays a created selection screen on the display unit.

9. The display processing apparatus according to claim 8, wherein the display processing unit creates the second selection screen on which the selected upper item symbol is enlarged and arranged on the display background, and displays a created second selection screen on the display unit.

10. The display processing apparatus according to claim 8, wherein
the storage unit stores therein the lower item symbols and the upper item symbols in an associated manner, and
the display processing unit reads a lower item symbol associated with the selected upper item symbol from the storage unit, creates the second selection screen on which a read lower item symbol is arranged on the display background, and displays a created second selection screen on the display unit.

11. The display processing apparatus according to claim 10, wherein the display processing unit creates the second selection screen on which a plurality of lower item symbols are arranged in a lattice on the display background, and displays a created second selection screen on the display unit.

12. The display processing apparatus according to claim 10, wherein the display processing unit creates the second selection screen on which the upper item symbols are arranged in an upper part of the display background, and the lower item symbol is arranged below the upper item symbols, and displays a created second selection screen on the display unit.

13. The display processing apparatus according to claim 1, wherein the display processing unit creates the second selection screen on which a line image connecting the upper item symbols is arranged between each of the upper item symbols on the display background, and displays a created second selection screen on the display unit.

14. A display processing method comprising:
displaying a first selection screen on which a plurality of upper item symbols corresponding to respective upper setting items are arranged; and
receiving a selection of an upper item symbol, wherein
when the selection of the upper item symbol is received, the displaying includes
shifting a selected upper item symbol to a specified width position with a predetermined width in a predetermined distance from one side of a screen, and
displaying a second selection screen on which other displayed upper item symbols are rearranged with an arrangement order unchanged.

15. A computer program product comprising a computer-usable medium having computer-readable program codes embodied in the medium that when executed cause a computer to execute:
displaying a first selection screen on which a plurality of upper item symbols corresponding to respective upper setting items are arranged; and
receiving a selection of an upper item symbol, wherein
when the selection of the upper item symbol is received, the displaying includes
shifting a selected upper item symbol to a specified width position with a predetermined width in a predetermined distance from one side of a screen, and
displaying a second selection screen on which other displayed upper item symbols are rearranged with an arrangement order unchanged.
